(19) United States
(12) Patent Application Publication
(10) Pub. No.: US 2015/0061393 A1
(43) Pub. Date: Mar. 5, 2015

(54) VARIABLE VOLTAGE CIRCUIT

(71) Applicant: TDK CORPORATION, Tokyo (JP)

(72) Inventors: Kuniyasu ITO, Tokyo (JP); Tetsuya SHIBATA, Tokyo (JP); Takahiro SUWA, Tokyo (JP); Katsuyuki NAKADA, Tokyo (JP); Masato TAKAHASHI, Tokyo (JP)

(21) Appl. No.: 14/471,974

(22) Filed: Aug. 28, 2014

(30) Foreign Application Priority Data
Aug. 28, 2013 (JP) 2013-176496
Aug. 25, 2014 (JP) 2014-170697

(51) Int. Cl. G05F 7/00

(52) U.S. Cl. CPC G05F 7/00
USPC 307/52

(57) ABSTRACT

In a variable voltage circuit 50, a resistive element 104 and a magnetoresistance effect element 108 are connected in series between a first voltage source 101 and a second voltage source 102. A magnetic field supply mechanism 121 that applies a magnetic field to the magnetoresistance effect element 108 is provided in the vicinity of the magnetoresistance effect element 108. The magnetic field supply mechanism 121 can vary the resistance value of the magnetoresistance effect element 108 by varying the magnetic field. A node 106 between the resistive element 104 and the magnetoresistance effect element 108 is connected to an output terminal 103.

### BACKGROUND

The present invention relates to a variable voltage circuit.

### BACKGROUND ART

In recent years, the widespread use of mobile telephones, smart phones, and other mobile terminals is significant. The resolution of liquid crystal displays and other display units used in these mobile terminals has been improved, and terminal bodies are being made compact and thin. The display unit disclosed in PTL 1 has a horizontal driving circuit that drives signal lines for each pixel row in the display unit. A digital/analog converter (referred to below as the D/A converter), into which a digital video signal is input and which converts it to an analog pixel driving signal, is incorporated in the horizontal driving circuit.

In conversion methods in D/A converters, a resistor ladder type, in which an operation function of an operational amplifier is used to turn on and off a resistor and obtain a target voltage from an applied voltage, and a resistor string type, in which resistors are connected in series and a connection is made at a necessary point with an analog switch, are often used. In the D/A converters described above, a voltage generating circuit that generates a plurality of output voltages is needed. This voltage generating circuit is formed separately from a display area, so together with other semiconductor circuits, the voltage generating circuit is desired to be compact and occupy less space.

In PTL 2, an example of the structure of a D/A converter of N-bit resistor string type is indicated.

V1 and V2 are first and second reference voltage sources, which are references for analog outputs. A resistor string formed with 2^{N} resistors R1, R2, R3, . . . , R2^{N}, which have the same resistance value, is connected in series depending on the resolution, is provided between the first and second reference voltage sources V1 and V2.

A total of 2^{N} taps T1, T2, . . . , T2^{N} are placed from connection points between the first reference voltage source V1 and the resistors of the resistor string so that the voltage between the first and second reference voltage sources V1 and V2 is divided into 2^{N}. Decode switches formed with an output VO and 2^{N} switches SW1, SW2, . . . , SW2^{N}, which are used to connect the taps T1, T2, . . . , T2^{N}, is provided. One ends of the switches SW1, SW2, . . . , SW2^{N} are connected to the output VO in common.

A desired analog output is obtained by receiving an N-bit digital input signal input from a digital signal input terminal VI, selecting one switch from the decode switches according to the digital value input by a control circuit, and closing (turning on) the selected switch.

### CITATION LIST

### Patent Literature

[PTL 1] Japanese Unexamined Patent Application Publication No. 2002-175021

[PTL 2] Japanese Unexamined Patent Application Publication No. 8-330964

### SUMMARY

However, since the structure of the conventional D/A converter, disclosed in PTL 2, in a resistor string method is a structure in which when resolution is N bits, a desired output is obtained by using 2^{N} resistors to fetch 2^{N} taps and selecting one switch from a plurality of switches, the circuit size of a decoding area used for switch selection is increased as resolution is increased, which has been problematic in that the circuit area is enlarged.

The present invention addresses the above problem with the object of providing a variable voltage circuit that has a voltage output function equivalent to an N-bit D/A converter, the output function being achieved with few elements, and can implement a reduced circuit size.

To solve the above problem, the variable voltage circuit in the present invention is characterized in that a plurality of resistive elements are connected in series between a first voltage source and a second voltage source, at least one of the plurality of resistive elements is a magnetoresistance effect element that has a magnetization fixed layer and a magnetization free layer with a spacer layer interposed therebetween, a magnetic field supply mechanism that applies a magnetic field to the magnetoresistance effect element is provided in the vicinity of the magnetoresistance effect element, the magnetic field supply mechanism can vary the resistance value of the magnetoresistance effect element by varying the magnetic field, and one of nodes among the plurality of resistive elements is connected to an output terminal.

According to the variable voltage circuit characterized as described above, when the magnetic field supply mechanism varies the magnetic field to be applied to the magnetoresistance effect element, which is at least one of the plurality of resistive elements connected in series between the first voltage source and the second voltage source, a voltage obtained from the output terminal can be varied.

Since the resistance value of the magnetoresistance effect element is varied, the variable voltage circuit characterized as described above enables more types of output voltages to be obtained than with a conventional variable voltage circuit formed with the same number of fixed resistors. When the same types of output voltages as for the conventional variable voltage circuit are output, the number of resistive elements and the number of switches can be reduced when compared with the conventional variable voltage circuit, so a variable voltage circuit with a reduced circuit size can be provided.

The “first voltage source” and “second voltage source” indicated here includes a case in which any one of them is grounded. That is, it is only necessary that there is an electric potential difference between the “first voltage source” and “second voltage source”. The “node” means a point at which two resistive elements are connected. A connection to a switch or another network starts from this point. The node is the same as the tap indicated in PTL 2. The “switch” is an opened and closed device placed between a node and the output terminal. When the switch is closed (turned on), the node and output terminal are brought into conduction. Switches include mechanical switches that mechanically make a switchover between electric signals in response to an external force and semiconductor switches that use a CMOS transistor or the like to connect or disconnect a circuit. Selection of a certain node is to close the switch connected to the node and bring it into conduction with the output terminal; the node has the same electric potential as the output terminal. “Vicinity” means a distance up to which a magnetic field generated from the magnetic field supply mechanism can be applied to the magnetoresistance effect element. The distance from a side surface of the magnetoresistance effect element to the magnetic field generating end of the magnetic field supply mechanism is within a range of 5 [nm] to 1 [μm].

The variable voltage circuit in the present invention is also characterized in that it is structured so that a plurality of resistance values are obtained as at least one of a first resistance value between the first voltage source and the output terminal and a second resistance value between the second voltage source and the output terminal and a plurality of types of output voltages are thereby obtained according to voltage division ratios obtained from the first resistance value and second resistance value.

The variable voltage circuit in the present invention is also characterized in that a plurality of the magnetoresistance effect elements are included as the plurality of resistive elements, and the magnetization free layers of at least two of the plurality of magnetoresistance effect elements have mutually different coercive forces.

According to the variable voltage circuit characterized as described above, even when the same magnetic field is applied to at least two magnetoresistance effect elements in which their magnetization free layers have mutually different coercive forces, types of the entire resistance value of the magnetoresistance effect elements connected in series can be increased by varying the magnetic field and types of obtained output voltages can thereby be increased.

The variable voltage circuit in the present invention is also characterized in that a plurality of the magnetoresistance effect elements are included as the plurality of resistive elements, and at least one magnetic field supply mechanism is provided in the vicinity of each of the magnetoresistance effect elements.

According to the variable voltage circuit characterized as described above, more types of output voltages can be obtained by controlling the magnetic field that is individually applied to each magnetoresistance effect element to vary its resistance value.

The variable voltage circuit in the present invention is also characterized in that the magnetic field supply mechanism can vary the resistance value of the magnetoresistance effect element by changing the magnetization direction in the magnetization free layer with the magnetic field.

According to the variable voltage circuit characterized as described above, when the magnetization direction in the magnetization free layer is changed to two states, a state substantially parallel to the magnetization direction in the magnetization fixed layer and a state substantially antiparallel to the magnetization direction, the resistance value of the magnetoresistance effect element can be largely varied, so differences among a plurality of types of obtained output voltages can be increased. When the angle of the magnetization direction in the magnetization free layer with respect the magnetization direction in the magnetization fixed layer is varied to an arbitrary angle, the resistance value of the magnetoresistance effect element can be changed to an arbitrary value, so many types of output voltages can be obtained.

The variable voltage circuit in the present invention is also characterized in that the magnetic field supply mechanism can vary the resistance value of the magnetoresistance effect element by varying the strength of a magnetic field to be applied to the magnetization free layer.

According to the variable voltage circuit characterized as described above, the resistance value of the magnetoresistance effect element can be continuously varied, so many types of output voltages can be obtained.

The variable voltage circuit in the present invention is also characterized in that two series resistor parts, in each of which the plurality of resistive elements are connected in series, are provided and the two series resistor parts are connected in parallel.

According to the variable voltage circuit characterized as described above, the range of the voltage division ratio can be widened, so the output voltage range can be widened.

The variable voltage circuit in the present invention is also characterized in that the magnetic field supply mechanism maintains the resistance value of the magnetoresistance effect element by applying the magnetic field to the magnetoresistance effect element.

According to the variable voltage circuit characterized as described above, the resistance value of the magnetoresistance effect element is stabilized, so a stable output voltage is obtained.

The variable voltage circuit in the present invention is also characterized in that the magnetization direction in the magnetization fixed layer of the magnetoresistance effect element and the magnetization direction in the magnetization free layer of the magnetoresistance effect element are maintained in a substantially parallel direction or substantially antiparallel direction even in a state in which the magnetic field is not generated from the magnetic field supply mechanism.

“Substantially parallel” and “substantially antiparallel” should not be interpreted as narrowly limiting only to cases in which the angle formed by the magnetization direction in the magnetization fixed layer and the magnetization direction in the magnetization free layer is 0° and 180° but are used to include cases in which the angle is about 0°±20° and about 180°±20°.

According to the variable voltage circuit characterized as described above, the resistance value of the magnetoresistance effect element is maintained even in a state in which the magnetic field is not generated from the magnetic field supply mechanism, so electric power used to drive the magnetic field supply mechanism to apply a magnetic field to the magnetoresistance effect element can be conserved.

### Advantageous Effects of Invention

According to the present invention, it is possible to provide a variable voltage circuit that has a voltage output function equivalent to an N-bit D/A converter, the output function being achieved with few elements, and can implement a reduced circuit size.

### BRIEF DESCRIPTION OF THE DRAWINGS

FIG. 1 schematically illustrates a variable voltage circuit according to a first embodiment of the present invention.

FIG. 2 is a schematic cross sectional view of a magnetoresistance effect element.

FIG. 3 schematically illustrates a variable voltage circuit according to a second embodiment of the present invention.

FIG. 4 schematically illustrates a variable voltage circuit according to a third embodiment of the present invention.

FIG. 5 is a graph representing the strength of a magnetic field applied to a magnetoresistance effect element according to the third embodiment of the present invention and the resistance value of the magnetoresistance effect element.

FIG. 6 schematically illustrates a variable voltage circuit according to a fourth embodiment of the present invention.

FIG. 7 schematically illustrates an example in which one coil is connected in the schematic drawing of the variable voltage circuit according to the fourth embodiment of the present invention.

FIG. 8 schematically illustrates a variable voltage circuit according to a fifth embodiment of the present invention.

FIG. 9 schematically illustrates a variable voltage circuit according to a sixth embodiment of the present invention.

FIG. 10 schematically illustrates a variable voltage circuit according to a seventh embodiment of the present invention.

FIG. 11 schematically illustrates a variable voltage circuit according to an eighth embodiment of the present invention.

FIG. 12 illustrates the magnetic characteristics of a magnetoresistance effect element in an example.

FIG. 13 is a graph representing a relationship between a current flowing in a coil in an embodiment and a generated magnetic field.

### DETAILED DESCRIPTION OF EMBODIMENTS

Preferred embodiment of the present invention will be described below with reference to the drawings. The present invention is not limited to the embodiments below. Constituent elements described below include elements that a person having ordinary skill in the art can easily assume and elements substantially identical to these elements. In addition, the elements described below can be appropriately combined.

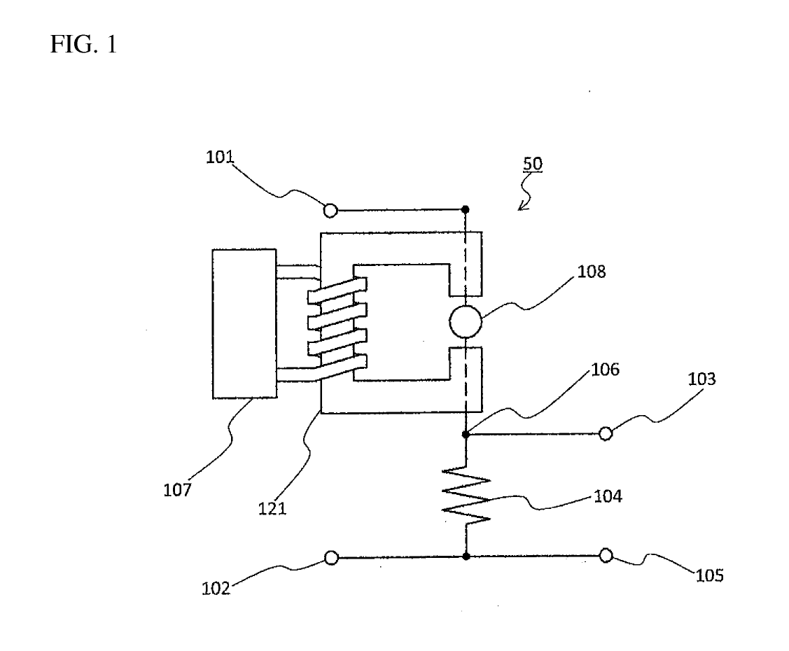

The structure of a variable voltage circuit 50 according to a first embodiment of the present invention will be described with reference to FIG. 1.

In the variable voltage circuit 50 illustrated in FIG. 1, a plurality of resistive elements are connected in series between a first voltage source 101 and a second voltage source 102. More specifically, a resistive element 104 and a magnetoresistance effect element 108, which is used as a resistive element, are placed in series on a wire that connects the first voltage source 101 and second voltage source 102 together. A node 106 is provided between the resistive element 104 and the magnetoresistance effect element 108. The node 106 is connected to an output terminal 103. The output terminal 105 has the same electric potential as the second voltage source 102. An electric potential difference between the first voltage source 101 and the second voltage source 102 is divided by the resistive element 104 and magnetoresistance effect element 108. Output voltages divided according to the voltage division ratio are output from the output terminals 103 and 105.

The “first voltage source” and “second voltage source” indicated here include a case in which any one of them is grounded. That is, it is only necessary that there is an electric potential difference between the “first voltage source” and “second voltage source”.

The “node” means a point at which two resistive elements are connected. A connection to a switch or another network starts from this point. The node is the same as the tap indicated in PTL 2.

A magnetic field supply mechanism 121 is provided in the vicinity of the magnetoresistance effect element 108 in the variable voltage circuit 50 illustrated in FIG. 1. A magnetic field generated from the magnetic field supply mechanism 121 is applied to the magnetoresistance effect element 108. The magnetic field supply mechanism 121 can vary the resistance value of the magnetoresistance effect element 108 by varying the magnetic field to be applied to the magnetoresistance effect element 108 to vary the magnetization direction in the magnetization free layer of the magnetoresistance effect element 108.

“Vicinity” means a distance up to which a magnetic field generated from the magnetic field supply mechanism 121 can be applied to the magnetoresistance effect element 108. The distance from a side surface of the magnetoresistance effect element to the magnetic field generating end of the magnetic field supply mechanism is within a range of 5 [nm] to 1 [μm].

The variable voltage circuit 50 illustrated in FIG. 1 is structured so that a plurality of resistance values are obtained as at least one of a first resistance value between the first voltage source 101 and the output terminal 103 and a second resistance value between the second voltage source 102 and the output terminal 103 (in this example, the first resistance value) and can thereby obtain a plurality of types of output voltages according to voltage division ratios obtained from the first resistance value and second resistance value.

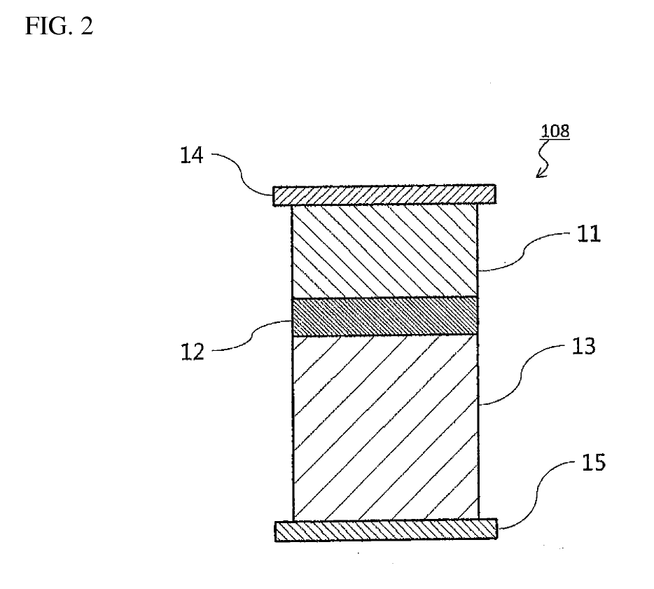

FIG. 2 is a schematic cross sectional view of the magnetoresistance effect element 108. The magnetoresistance effect element 108 is structured so that a magnetization free layer 11, a spacer layer 12, and a magnetization fixed layer 13 are laminated between an electrode 14 and an electrode 15. A current flows in a lamination direction between the electrode 14 and the electrode 15. The magnetization free layer 11 can have a lamination structure formed with, for example, a CoFe alloy and a CoFe alloy with a different composition or with a CoFeB alloy and a CoFe alloy. The spacer layer 12 can be made of, for example, MgO. The magnetization fixed layer 13 can have a lamination structure formed with, for example, a CoFe alloy and a CoFe alloy with a different composition or with a CoFeB alloy and a CoFeB alloy.

In the magnetoresistance effect element 108, the magnetization free layer 11 is affected by an external magnetic field generated from the magnetic field supply mechanism 121. Due to the external magnetic field from the magnetic field supply mechanism 121, the direction in the magnetization of the magnetization free layer 11 is changed so that it matches the direction of the external magnetic field generated from the magnetic field supply mechanism 121. At this time, the magnetization direction in the magnetization fixed layer 13 is not changed because the magnetization direction is determined by ferromagnetic coupling. When an angle formed by the magnetization direction in the magnetization free layer 11 of the magnetoresistance effect element 108 and the magnetization direction in the magnetization fixed layer 13 of the magnetoresistance effect element 108 is varied, the resistance value of the magnetoresistance effect element 108 is varied.

The magnetic field supply mechanism 121 has a magnetic core made of a magnetic material such as a permalloy and a coil with a conductor wound around the magnetic core, the coil being connected to a current generating source 107. The magnetic field supply mechanism 121 is structured so that a magnetic field, which is generated by flowing a current from the current generating source 107 into the conductor, is applied through the magnetic core to the magnetoresistance effect element 108. The magnetic field supply mechanism 121 changes the magnetization direction in the magnetization free layer 11 to two states, a state parallel to the magnetization direction in the magnetization fixed layer 13 and a state antiparallel to the magnetization direction. Even after the magnetization direction in the magnetization free layer 11 has been changed, the magnetic field supply mechanism 121 applies a magnetic field to the magnetoresistance effect element 108 to maintain the resistance value of the magnetoresistance effect element 108.

The magnetic field supply mechanism 121 can be formed at the same time by using a thin-film process that forms the magnetoresistance effect element 108. Therefore, the size of the magnetic field supply mechanism 121 can be restricted to abut the size of the magnetoresistance effect element 108; the size of the magnetic field supply mechanism 121 can be restricted to about 200 micrometer square.

As the structure of the magnetic field supply mechanism 121, a structure can be considered in which part of a magnetic core in a closed magnetic circuit is cut and the magnetoresistance effect element 108 is placed therein. Since the magnetoresistance effect element 108 is placed in an inside of the closed magnetic circuit, in which a magnetic flux is easily transmitted, the inside being the part cut from the closed magnetic circuit, a leak magnetic field from the magnetic core can be efficiently applied to the magnetoresistance effect element 108. The strength of the magnetic field can be varied by varying a current flowing from the current generating source 107 to the coil.

In the magnetoresistance effect element 108 illustrated in FIG. 2, the magnetization direction in the magnetization free layer 11 on the upper side can be changed. In the magnetization fixed layer 13 on the lower side, IrMn, which is an antiferromagnetic material, is laminated, making it impossible to change the magnetization direction. If the magnetization direction in the magnetization free layer 11 and the magnetization direction in the magnetization fixed layer 13 are parallel, the resistance value of the magnetoresistance effect element 108 is minimized. If the magnetization direction in the magnetization free layer 11 and the magnetization direction in the magnetization fixed layer 13 are antiparallel, the resistance value of the magnetoresistance effect element 108 is maximized.

Although the material of the spacer layer 12 has been MgO, it is also possible to use, as the material of the non-magnetic spacer layer 12, an AlOx or TiO insulator, an alloy material that includes at least one of metallic elements Cu, Ag, Au, and Cr, or a zinc oxide, gallium oxide, tin oxide, indium oxide or indium tin oxide semiconductor.

The type of antiferromagnetic material that makes the magnetization direction in the magnetization fixed layer 13 unchangeable is not limited to IrMn.

Furthermore, the order in which the magnetization free layer 11 and magnetization fixed layer 13 are laminated between the electrode 14 and the electrode 15 may be vertically inverted. The magnetoresistance effect element 108 can have a structure similar to the structure of a magnetoresistance effect element used in a known MRAM or HDD read head or the like.

With the variable voltage circuit in the present invention, to obtain various voltage division ratios, the magnetoresistance effect element 108 is preferably a magnetoresistance effect element having a large magnetoresistance ratio (MR ratio). Magnetoresistance effect elements from which a large magnetoresistance ratio is obtained include a giant magnetoresistance effect (GMR) element, a tunnel magnetoresistance effect (TMR) element, and a current perpendicular in place GMR (CPP-GMR) element. In particular, for the TMR element and CPP-GMR element, a large magnetoresistance ratio can be obtained by laminating a magnetization fixed layer and a magnetization free layer with a non-magnetic interposed therebetween and applying a current in the lamination direction.

In the variable voltage circuit 50, illustrated in FIG. 1, in the first embodiment, when the resistance value of the magnetoresistance effect element 108 is the maximum value R₃ₘₐₓ, a voltage division ratio is obtained from R₃ₘₐₓ and the resistance value R₂ of the resistive element 104. An output voltage V_{OUTmax} obtained from the output terminal 103 in this case is represented by an electric potential difference V_{H}−V_{L} between the first voltage source 101 and the second voltage source 102 and a voltage division ratio as in [Eq. 1].

$${V}_{OUTmax} = \frac{{R}_{2}}{{R}_{3 m ax} + {R}_{2}} ( {V}_{H} - {V}_{L} ) \qquad [ Eq . 1 ]$$

When the resistance value of the magnetoresistance effect element 108 is the minimum value R₃ₘᵢₙ, a voltage division ratio is obtained from R₃ₘᵢₙ and the resistance value R₂ of the resistive element 104. An output voltage V_{OUTmin} obtained from the output terminal 103 in this case is represented as in [Eq. 2].

$${V}_{OUTmin} = \frac{{R}_{2}}{{R}_{3 m i n} + {R}_{2}} ( {V}_{H} - {V}_{L} ) \qquad [ Eq . 2 ]$$

In the case of a conventional voltage circuit, in which two fixed resistors are connected in series, only one type of output voltage is obtained. As in the variable voltage circuit 50 illustrated in FIG. 1, however, if one of the two fixed resistors connected in series is changed to the magnetoresistance effect element 108, the magnetic field supply mechanism 121 is placed in the vicinity of the magnetoresistance effect element 108, the magnetization direction in the magnetization free layer 11 is changed by a magnetic field applied from the magnetic field supply mechanism 121, the magnetization direction in the magnetization free layer 11 is changed to two states, a state parallel to the magnetization direction in the magnetization fixed layer 13 and a state antiparallel to the magnetization direction, and the resistance value of the magnetoresistance effect element 108 is varied from the maximum value to the minimum value, then two types of output voltages can be obtained.

With the variable voltage circuit 50 in the first embodiment, when the magnetic field supply mechanism 121 varies a magnetic field to be applied to the magnetoresistance effect element 108, which is at least one of a plurality of resistive elements connected in series between the first voltage source 101 and the second voltage source 102, to vary the resistance value of the magnetoresistance effect element 108, the voltage obtained from the output terminal 103 can be varied.

When the resistance value of the magnetoresistance effect element 108 is varied, the variable voltage circuit 50 in the first embodiment enables more types of output voltages to be obtained than with a conventional variable voltage circuit formed with the same number of fixed resistors. When the same types of output voltages as for the conventional variable voltage circuit are output, the number of resistive elements and the number of switches can be reduced when compared with the conventional variable voltage circuit, so a variable voltage circuit with a reduced circuit size can be provided.

With the variable voltage circuit 50 in the first embodiment, the magnetic field supply mechanism 121 can vary the resistance value of the magnetoresistance effect element by changing the magnetization direction in the magnetization free layer 11 to two states, a state parallel to the magnetization direction in the magnetization fixed layer 13 and a state antiparallel to the magnetization direction, the resistance value of the magnetoresistance effect element 108 can be largely varied increased and differences among a plurality of types of obtained output voltages can thereby be increased.

With the variable voltage circuit 50 in the first embodiment, since the magnetic field supply mechanism 121 maintains the resistance value of the magnetoresistance effect element 108 by applying a magnetic field to the magnetoresistance effect element 108, the resistance value of the magnetoresistance effect element 108 is stabilized, so a stable output voltage can be obtained.

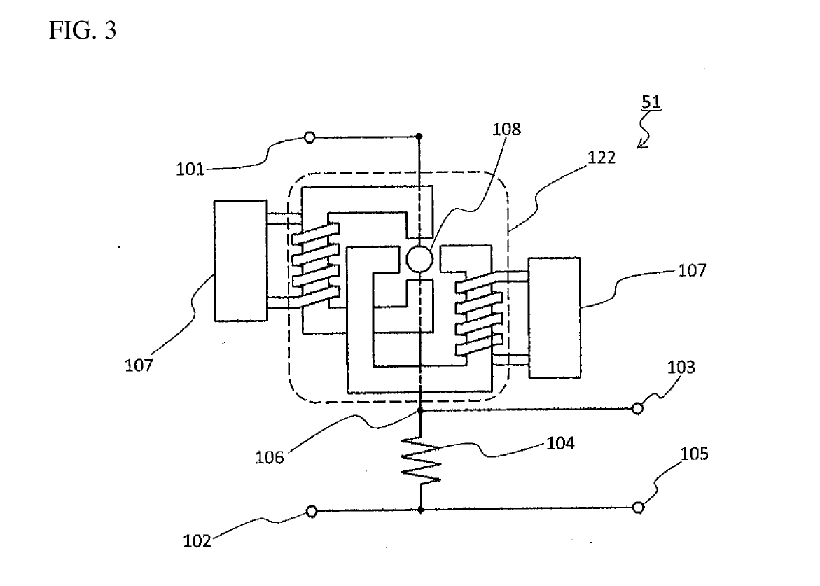

Next, the structure of a variable voltage circuit 51 according to a second embodiment of the present invention will be described with reference to FIG. 3.

The magnetic field supply mechanism 121 indicated in the first embodiment cannot change the magnetization direction in the magnetization free layer 11 to an arbitrary direction. In the second embodiment, a magnetic field supply mechanism 122 is used instead of the magnetic field supply mechanism 121 in the first embodiment, as illustrated in FIG. 3. Other structures are the same as in the first embodiment.

As illustrated in FIG. 3, the magnetic field supply mechanism 122 has two magnetic cores with a coil wound around each magnetic core; the magnetic cores are placed so that their magnetic poles are oriented in different directions. Therefore, if magnetic fields applied from the two magnetic cores are combined, a magnetic field can be applied to the magnetoresistance effect element 108 in an arbitrary direction.

By using the magnetic field supply mechanism 122, the magnetization direction in the magnetization free layer 11 can be changed to an arbitrary direction. Therefore, the resistance value of the magnetoresistance effect element 108 can be varied to an arbitrary value according to the angle formed by the magnetization direction in the magnetization fixed layer 13 and the magnetization direction in the magnetization free layer 11.

When the direction of the magnetic field to be applied to the magnetoresistance effect element 108 is arbitrarily changed by varying currents to be flowed to the coils of the two magnetic cores and the resistance value of the magnetoresistance effect element 108 is thereby varied to an arbitrary value, a plurality of output voltages V_{OUT} can be obtained from the output terminal 103 between the output voltages V_{OUTmax} and V_{OUTmin} indicated in [Eq. 1] and [Eq. 2].

As a result, more output voltages than the number of output voltages obtained in the first embodiment can be obtained. Although the number of output voltages obtained in the first embodiment has been 2, it is possible in the second embodiment to obtain as many output voltages as the number of arbitrary values to which the resistance value of the magnetoresistance effect element 108 can be set, so more types of output voltages are obtained.

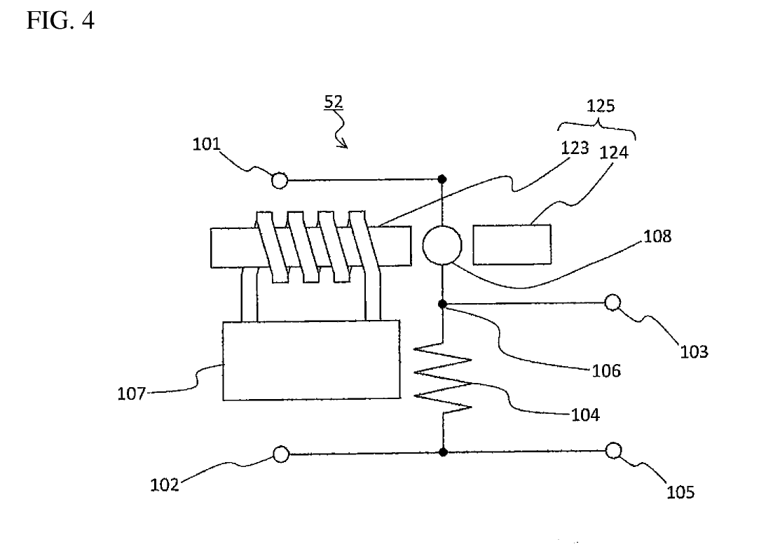

Next, the structure of a variable voltage circuit 52 according to a third embodiment of the present invention will be described with reference to FIG. 4.

The magnetic field supply mechanism 121 indicated in the first embodiment has a structure in which part of a magnetic core is cut and the magnetoresistance effect element 108 is placed therein. This structure is advantageous in that a magnetic field is efficiently applied, but may become complicated because the magnetic core needs to be place around the magnetoresistance effect element 108. In the third embodiment, a magnetic field supply mechanism 125 is used in which a magnetic core 123 with a coil wound around it is placed on one of sides interposing the magnetoresistance effect element 108 and a permanent magnet 124 is placed on the opposite side. Other structures are the same as in the first embodiment.

The magnetic core 123 does not have a closed magnetic circuit structure. One of the pole ends of the magnetic core 123 is placed in the vicinity of the magnetoresistance effect element 108.

The permanent magnet 124 is formed by using a thin-film process. Examples of thin-film permanent magnets include those formed by adding neodymium, samarium, or another rare-earth element to a material including FePt, Fe, Ni, Co, or the like.

The direction of a magnetic field applied from the magnetic core 123 and the direction of a magnetic field applied from the permanent magnet 124 are opposite to each other.

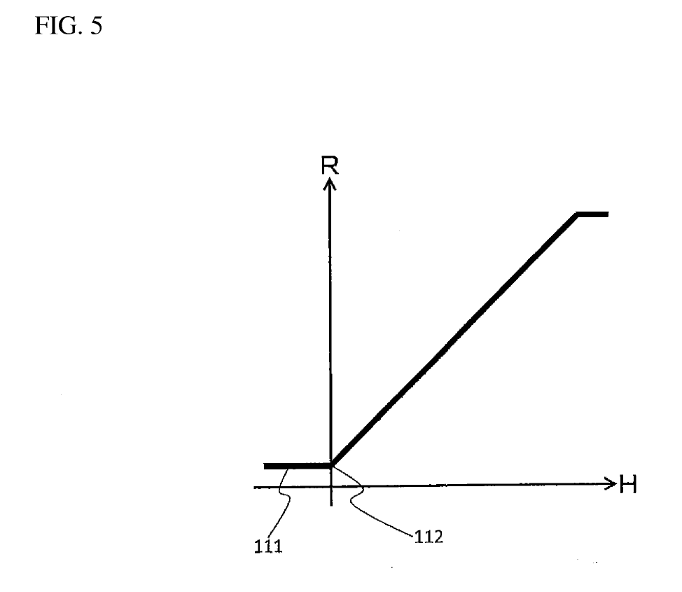

FIG. 5 illustrates a graph representing a relationship between a magnetic field applied to the magnetoresistance effect element 108 and the resistance value of the magnetoresistance effect element 108. In FIG. 5, the horizontal axis indicates magnetic field H and the vertical axis indicates resistance value R.

A point 111 in FIG. 5 indicates a case in which no magnetic field is applied from the magnetic field supply mechanism 123 and only a magnetic field from the permanent magnet 124 is applied to the magnetoresistance effect element 108. At this time, the magnetization direction in the magnetization free layer 11 and the magnetization direction in the magnetization fixed layer 13 are parallel and the resistance value of the magnetoresistance effect element 108 is thereby minimized. If a magnetic field from the magnetic core 123 is applied in this state, the magnetic field from the permanent magnet 124 is weakened by the magnetic field from the magnetic core 123. As the strength of the magnetic field from the magnetic core 123 is increased, a point at which the magnetic field from the magnetic core 123 and the magnetic field from the permanent magnet 124 are balanced appears as indicated by a point 112. If the magnetic field applied from the magnetic core 123 is further strengthened, the resistance value of the magnetoresistance effect element 108 starts to continuously vary. If the magnetic field applied from the magnetic core 123 becomes adequately larger than the magnetic field applied from the permanent magnet 124, the magnetization direction in the magnetization free layer 11 is inverted. Then, the magnetization direction in the magnetization free layer 11 and the magnetization direction in the magnetization fixed layer 13 become antiparallel, maximizing the resistance value of the magnetoresistance effect element 108.

In the variable voltage circuit 52 indicated in the third embodiment, the magnetic field supply mechanism 125 can vary the resistance value of the magnetoresistance effect element by varying the strength of the magnetic field to be applied to the magnetization free layer 11 as described above, the resistance value of the magnetoresistance effect element 108 can be continuously varied. Therefore, many types of output voltages V_{OUT} can be obtained from the output terminal 103 between the output voltages V_{OUTmax} and V_{OUTmin} indicated in [Eq. 1] and [Eq. 2].

According to the variable voltage circuit 52 indicated in the third embodiment, the structure around the magnetoresistance effect element 108 can be simplified when compared with a magnetic field supply mechanism having a structure in which part of a magnetic core is cut and the magnetoresistance effect element 108 is placed therein as in the first embodiment. Accordingly, the element size of a combination of the magnetoresistance effect element 108 and magnetic field supply mechanism 125 can be more reduced.

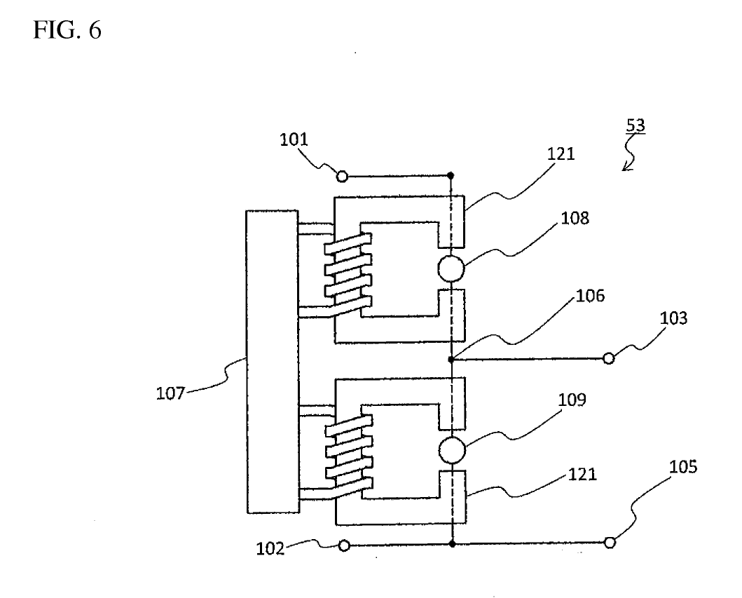

Next, the structure of a variable voltage circuit 53 according to a fourth embodiment of the present invention will be described with reference to FIG. 6.

In the fourth embodiment, the resistive element 104 in the variable voltage circuit 50 indicated in the first embodiment is replaced with a magnetoresistance effect element 109 and the magnetic field supply mechanism 121 is placed in the vicinity of the magnetoresistance effect element 109 as well, as illustrated in FIG. 6. The node 106 between the magnetoresistance effect elements 108 and 109 is connected to the output terminal 103. A film structure as explained for the magnetoresistance effect element 108 can be used as the film structure of the magnetoresistance effect element 109.

Magnetic fields to be applied to the magnetoresistance effect elements 108 and 109 are controlled by their respective magnetic field supply mechanisms 121. The magnetization free layers 11 of the magnetoresistance effect elements 108 and 109 are affected by the magnetic fields applied from magnetic field supply mechanisms 121. When the angle formed by the magnetization direction in the magnetization fixed layer 13 and the magnetization direction in the magnetization free layer 11 in the magnetoresistance effect elements 108 and 109 is varied, the resistance values of the magnetoresistance effect element 108 and 109 are varied. With the variable voltage circuit 53 illustrated in FIG. 6, an output voltage is obtained according to the voltage division ratio obtained from the resistance values of the magnetoresistance effect elements 108 and 109.

In the variable voltage circuit 53 according to the fourth embodiment, the resistance values of the magnetoresistance effect elements 108 and 109 will be denoted R₃ and R₄. Table 1 shows combinations of the maximum values and minimum values of R₃ and R₄ and also shows the output voltage V_{OUT} obtained from the output terminal 103 for each combination.

TABLE 1

| R₃ | R₄ | VOUT |
|---|---|---|
| R₃ₘₐₓ | R₄ₘₐₓ | ${V}_{out} = \frac{{R}_{4 max}}{{R}_{3 max} + {R}_{4 max}} ( {V}_{H} - {V}_{L} )$ |
| R₃ₘₐₓ | R₄ₘᵢₙ | ${V}_{out} = \frac{{R}_{4 min}}{{R}_{3 max} + {R}_{4 min}} ( {V}_{H} - {V}_{L} )$ |
| R₃ₘᵢₙ | R₄ₘₐₓ | ${V}_{out} = \frac{{R}_{4 max}}{{R}_{3 min} + {R}_{4 max}} ( {V}_{H} - {V}_{L} )$ |
| R₃ₘᵢₙ | R₄ₘᵢₙ | ${V}_{out} = \frac{{R}_{4 min}}{{R}_{3 min} + {R}_{4 min}} ( {V}_{H} - {V}_{L} )$ |

In Table 1, the maximum values of the resistance values of the magnetoresistance effect elements 108 and 109 are denoted R₃ₘₐₓ and R₄ₘₐₓ and their minimum values are denoted R₃ₘᵢₙ and R₄ₘᵢₙ. The voltage division ratio is determined from the resistance values of the magnetoresistance effect elements 108 and 109. The output voltage V_{OUT} according to the voltage division ratio is indicated in Table 1. With the variable voltage circuit 50 in the first embodiment, when the resistance value of the magnetoresistance effect element 108 is maximized and minimized, two types of output voltages have been obtained. With the variable voltage circuit 53 in the fourth embodiment, however, if the values of R₃ₘₐₓ, R₄ₘₐₓ, R₃ₘᵢₙ, and R₄ₘᵢₙ are different, four types of output voltages can be obtained according to combinations of resistance values when the resistance values of the magnetoresistance effect elements 108 and 109 are maximized and minimized. Even in the case of R₃ₘₐₓ=R₄ₘₐₓ and R₃ₘᵢₙ=R₄ₘᵢₙ, three types of output voltages can be obtained.

Since the variable voltage circuit 53 in the fourth embodiment includes a plurality of magnetoresistance effect elements 108 and 109 and at least one magnetic field supply mechanism 121 is provided for each magnetoresistance effect element as described above, when the magnetic field supply mechanisms 121 individually control magnetic fields to be applied to the magnetoresistance effect elements 108 and 109 to vary the resistance values of the magnetoresistance effect elements 108 and 109, more types of output voltages can be obtained.

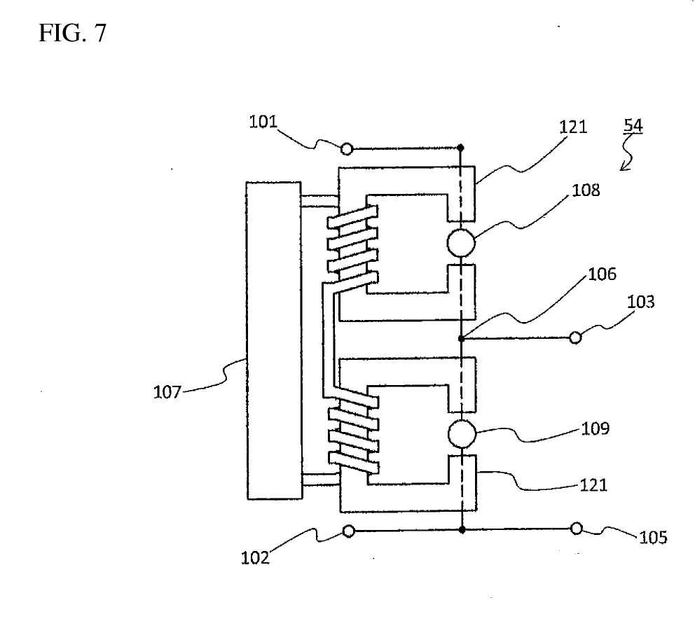

Although, with the fourth embodiment illustrated in FIG. 6, the magnetic field supply mechanisms 121 that apply magnetic fields to the magnetoresistance effect elements 108 and 109 are individually controlled, a method of controlling the magnetic field supply mechanisms 121 at one time by connecting their coils into one as in a variable voltage circuit 54 illustrated in FIG. 7 can also be considered. In this method, the coil in the vicinity of the magnetoresistance effect element 108 and the coil in the vicinity of the magnetoresistance effect element 109 are wound around the relevant magnetic coils so that their winding directions are opposite.

With the structure of the variable voltage circuit 54 illustrated in FIG. 7, when a current is flowed from the current generating source 107 to the coil of the magnetic field supply mechanism 121, magnetic fields can be applied to the magnetoresistance effect elements 108 and 109 in opposite directions.

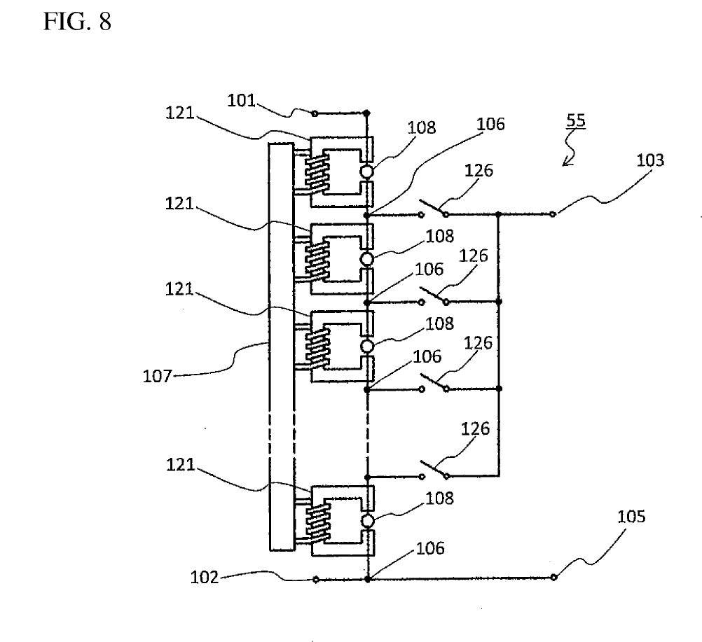

Next, the structure of a variable voltage circuit 55 according to a fifth embodiment of the present invention will be described with reference to FIG. 8.

With the variable voltage circuit 55 in the fifth embodiment, a plurality of magnetoresistance effect elements 108 are connected in series, the node 106 is provided between each two magnetoresistance effect elements 108, and a selector switch 126 is connected to each node 106. A terminal, of each selector switch 126, that is not connected to the node 106 is connected to the output terminal 103. When one of the switches 126 is closed, the node 106 connected to the closed selector switch 126 and the output terminal 103 have the same electric potential. One magnetic field supply mechanism 121 is placed in the vicinity of each magnetoresistance effect element 108. A magnetic field to be applied to the magnetoresistance effect element 108 is individually controlled by the relevant magnetic field supply mechanism 121; each magnetic field supply mechanism 121 can change the magnetization direction in the magnetization free layer 11 of the relevant magnetoresistance effect element 108.

The “switch” indicated here is an opened and closed device placed between the node 106 and the output terminal 103. When the switch 126 is turned on by being closed, the node 106 and output terminal 103 are brought into conduction. Switches include mechanical switches that mechanically make a switchover between electric signals in response to an external force and semiconductor switches that use a CMOS transistor or the like to connect or disconnect a circuit. Selection of a certain node is to close the switch connected to the node and bring it into conduction with the output terminal; the node has the same electric potential as the output terminal.

The magnetization direction in the magnetization free layer 11 of the magnetoresistance effect element 108 is changed by varying the magnetic field applied from the magnetic field supply mechanism 121. Thus, an angle formed by the magnetization direction in the magnetization free layer 11 and the magnetization direction in the magnetization fixed layer 13 is varied. When the angle formed by the magnetization direction in the magnetization free layer 11 and the magnetization direction in the magnetization fixed layer 13 is varied, the resistance value of the magnetoresistance effect element 108 is varied. While the resistance values of the magnetoresistance effect elements 110 being maintained, when any one of the switches 126 is closed and its relevant node 106 and output terminal 103 thereby have the same electric potential, an output voltage obtained according to the voltage division ratio obtained by a first resistance value from the first voltage source to the node 106 connected to the closed selector switch 126 and a second resistance value from the second voltage source to the node 106 connected to the closed selector switch 126.

If, in the variable voltage circuit 55 in the fifth embodiment, each magnetoresistance effect element 108 is assumed to maintain its maximum resistance value or minimum resistance value, then the number of magnetoresistance effect elements 108, the number of switches 126, and the number of obtained output voltages are as indicated in Table 2. In Table 2, the number of magnetoresistance effect elements is indicated by R_{N}, the number of switches is indicated by S_{N}, and the number of output voltages is indicated by V_{N}.

TABLE 2

| R_{N} | S_{N} | V_{N} |
|---|---|---|
| 3 | 2 | 16 |
| 4 | 3 | 48 |
| 5 | 4 | 128 |
| 6 | 5 | 320 |
| 7 | 6 | 768 |
| 8 | 7 | 1792 |
| 9 | 8 | 4096 |
| 10 | 9 | 9216 |
| . | . | . |
| . | . | . |
| . | . | . |
| N | N − 1 | (N − 1) × 2^{N} |

The variable voltage circuit 55 in the fifth embodiment can obtain (N−1)×2^{N} times more reference voltages than from 2^{N} stages in the D/A converter in the resistor string type indicated in PTL 2.

More specifically, the eight-bit D/A converter indicated in PTL 2 needs 2⁸ (=256) fixed resistors. With this converter, while a tap position is switched, an output voltage is obtained according to the voltage division ratio obtained from a resistance value from the first voltage source to the tap position and a resistance value from the second voltage source to the tap position. By contrast, with the variable voltage circuit 55 indicated in the fifth embodiment, due to combinations of two conditions, maintaining the resistance value of each magnetoresistance effect element 108 at its maximum value or minimum value and making a switchover among the switches 126, when eight magnetoresistance effect elements 108, the number of magnetoresistance effect elements 108 being the same as the number of resistive elements, are used, output voltages are obtained at (8−1)×2⁸ (=1792) stages.

To obtain output voltages at about 256 stages as in the D/A converter in the resistor string type indicated in PTL 2 with variable voltage circuit 55 indicated in the fifth embodiment, the variable voltage circuit 55 is required to have six magnetoresistance effect elements. In this case, output voltages are obtained at (6−1)×2⁶ (=320) stages.

Thus, when the variable voltage circuit 55 indicated in the fifth embodiment is used, functions similar to functions of a conventional variable voltage circuit are implemented and the number of resistive elements can be significantly reduced.

In comparison of the variable voltage circuit used in the D/A converter indicated in PTL 2 and the variable voltage circuit 55 according to the fifth embodiment of the present invention, when the variable voltage circuit 55 according to the fifth embodiment is used, a circuit can be structured with a small number of parts. When an eight-bit D/A converter is taken as an example, the number of resistive elements in PTL 2 is 256, but in the variable voltage circuit 55 according to the fifth embodiment, the number of magnetoresistance effect elements is 6, indicating that the variable voltage circuit 55 can have comparable functions with about 3% of the resistive elements and its circuit size can thereby be reduced. When the circuit size is reduced, the area of the circuit board can be reduced and a compact variable voltage circuit can be achieved.

Although the variable voltage circuit 55 in the fifth embodiment has magnetic field supply mechanisms 121, even if magnetoresistance effect elements 108 and magnetic field supply mechanisms 121 are included, the variable voltage circuit 55 can be restricted to 0.2 [mm]×0.2 [mm] or smaller. This size is equal to or smaller than the size of the 0402-type fixed resistor, which is the smallest in the conventional surface-mounted fixed resistors. Therefore, the variable voltage circuit 55 indicated in the fifth embodiment can be structured with a smaller area than the conventional D/A converter in a resistance string method, so more output voltages can be obtained.

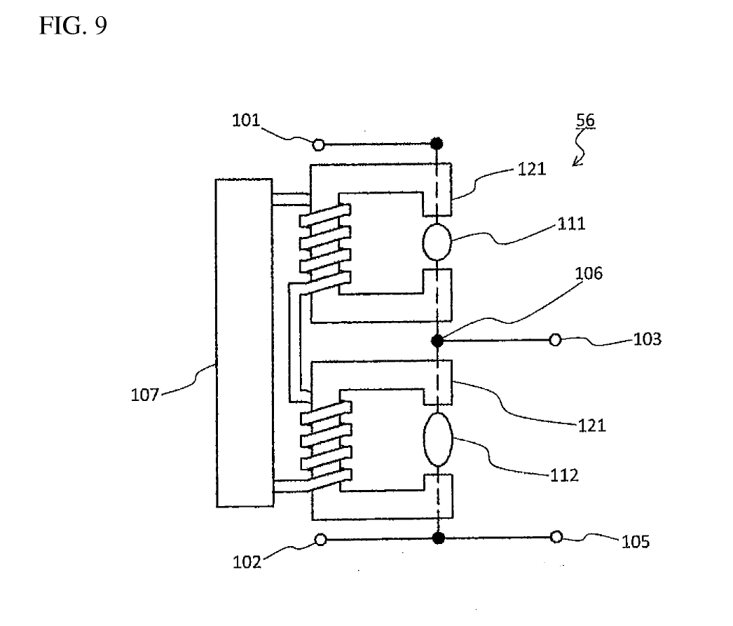

Next, the structure of a variable voltage circuit 56 according to a sixth embodiment of the present invention will be described with reference to FIG. 9.

In the variable voltage circuit 56 in the sixth embodiment illustrated in FIG. 9, magnetoresistance effect elements 111 and 112 are placed on a wire that connects the first voltage source 101 and second voltage source 102 together, and the magnetic field supply mechanism 121 is disposed in the vicinity of each of the magnetoresistance effect elements 111 and 112. A film structure as explained for the magnetoresistance effect element 108 can be used as the film structures of the magnetoresistance effect elements 111 and 112.

With the magnetoresistance effect elements 111 and 112, the magnetization direction in the magnetization fixed layer 13 is parallel to the direction in which the magnetic field supply mechanism 121 applies a magnetic field. The cross section of the magnetization free layer 11 of the magnetoresistance effect elements 111 and 112, the cross section being perpendicular to the lamination direction of the laminated layers in the magnetoresistance effect elements 111 and 112, is an ellipse. Therefore, the magnetization free layer 11 of the magnetoresistance effect elements 111 and 112 has shape magnetic anisotropy. The major axis of the ellipse is parallel to the magnetization direction in the magnetization fixed layer 13.

Thus, even if no magnetic field is applied from the magnetic field supply mechanism 121, the magnetization direction in the magnetization free layer 11 of the magnetoresistance effect elements 111 and 112 is maintained, so the magnetization direction in the magnetization fixed layer 13 of the magnetoresistance effect elements 111 and 112 and the magnetization direction in their magnetization free layer 11 are maintained in a substantially parallel state or a substantially antiparallel state.

“Substantially parallel” and “substantially antiparallel” should not be interpreted as narrowly limiting only to cases in which the angle formed by the magnetization direction in the magnetization fixed layer 13 and the magnetization direction in the magnetization free layer 11 is 0° and 180° but are used to include cases in which the angle is about 0°±20° and about 180°±20°.

According to the variable voltage circuit 56 in the sixth embodiment, therefore, the resistance values of the magnetoresistance effect elements 111 and 112 are maintained even in a state in which the magnetic field is not generated from the magnetic field supply mechanism 121, eliminating the need to continue to apply a magnetic field from the magnetic field supply mechanism 121. Therefore, electric power used to drive the magnetic field supply mechanisms 121 to apply a magnetic field to the magnetoresistance effect elements 111 and 112 can be conserved.

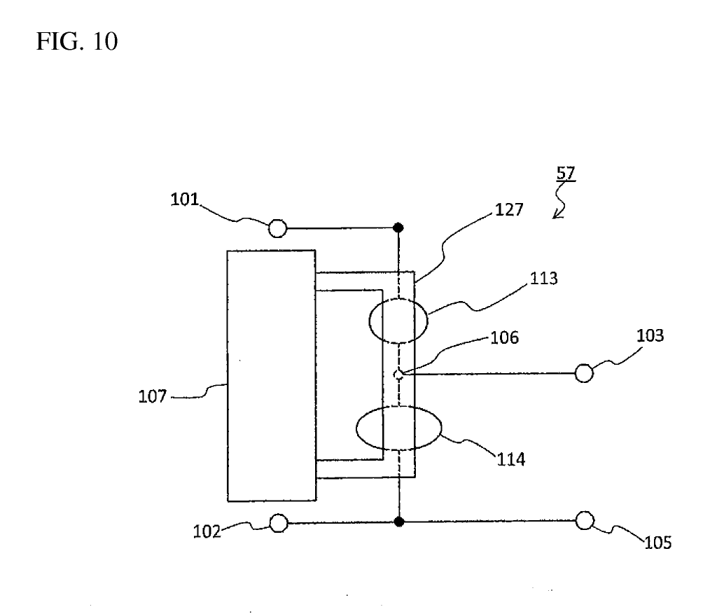

Next, the structure of a variable voltage circuit 57 according to a seventh embodiment of the present invention will be described with reference to FIG. 10.

In the variable voltage circuit 57 in the seventh embodiment illustrated in FIG. 10, magnetoresistance effect elements 113 and 114 are placed on a wire that connects the first voltage source 101 and second voltage source 102 together, and a magnetic field supply mechanism 127 is disposed in the vicinity of the magnetoresistance effect elements 113 and 114. A film structure as explained for the magnetoresistance effect element 108 can be used as the film structures of the magnetoresistance effect elements 113 and 114.

The magnetic field supply mechanism 127, which is placed in the vicinity of the magnetoresistance effect elements 113 and 114, is connected to the current generating source 107. The magnetic field supply mechanism 127 is a conductor made of Au, Cu, Al, or another metal or an alloy including them. When a current is applied to the conductor, a magnetic field is generated around the conductor.

The current generating source 107 can apply not only a constant current but also a pulse current to the magnetic field supply mechanism 127.

The magnetic field supply mechanism 127 and the magnetoresistance effect elements 113 and 114 are fixed with a certain interval maintained. The magnetic field supply mechanism 127 is desirably placed at a position close to the magnetization free layers 11 of the magnetoresistance effect elements 113 and 114.

When a current is applied from the current generating source 107 to the magnetic field supply mechanism 127, a magnetic field is generated from the magnetic field supply mechanism 127, varying the magnetization direction in the magnetization free layer 11 of the magnetoresistance effect elements 113 and 114. Therefore, output voltages are obtained according to voltage division ratios obtained from the resistance values of the magnetoresistance effect elements 113 and 114.

The magnetization direction in the magnetization fixed layer 13 of the magnetoresistance effect elements 113 and 114 and the direction in which the magnetic field supply mechanism 127 applies a magnetic field to the magnetoresistance effect elements 113 and 114 are parallel.

The magnetization free layers 11 of the magnetoresistance effect elements 113 and 114 have mutually different coercive forces. The cross section, of the magnetization free layer 11 of the magnetoresistance effect elements 113 and 114, the cross section being perpendicular to the lamination direction of the laminated layers in the magnetoresistance effect elements 113 and 114, is an ellipse. Therefore, the magnetization free layer 11 of the magnetoresistance effect elements 113 and 114 has shape magnetic anisotropy. The major axis of the ellipse is parallel to the magnetization direction in the magnetization fixed layer 13. The magnetoresistance effect element 113 has a smaller ratio of the length of the major axis of the ellipse to the length of its minor axis than the magnetoresistance effect element 114. That is, the shape magnetic anisotropy of the magnetization free layer 11 in the magnetoresistance effect element 113 and that in the magnetoresistance effect element 114 are different, and the magnetization free layer 11 of the magnetoresistance effect element 113 has a smaller coercive force than the magnetization free layer 11 of the magnetoresistance effect element 114.

An exemplary case will be considered in which with the magnetization directions in the magnetization free layers 11 of the magnetoresistance effect element 113 and 114 being the same, a magnetic field is applied from the magnetic field supply mechanism 127 in a direction opposite to the magnetization directions in the magnetization free layers 11. In this case, if the strength of the magnetic field to be applied is between the coercive force of the magnetization free layer 11 of the magnetoresistance effect element 113 and the coercive force of the magnetization free layer 11 of the magnetoresistance effect element 114, the magnetization direction in the magnetization free layer 11 of the magnetoresistance effect element 113 is inverted, but the magnetization direction in the magnetization free layer 11 of the magnetoresistance effect element 114 is not inverted. If the strength of the magnetic field to be applied is larger than the coercive force of the magnetization free layer 11 of the magnetoresistance effect element 113 and the coercive force of the magnetization free layer 11 of the magnetoresistance effect element 114, both the magnetization directions in the magnetization free layers 11 of the magnetoresistance effect elements 113 and 114 are inverted.

As described above, even if the same magnetic field is applied to the magnetoresistance effect elements 113 and 114, when the magnetic field is varied, combinations of a plurality of types of magnetization states in the magnetization free layer 11 of the magnetoresistance effect elements 113 and 114 are obtained, so types of the entire resistance value of the magnetoresistance effect elements 113 and 114 connected in series can be increased. Accordingly, with the variable voltage circuit 57 in the seventh embodiment, types of obtained output voltages can be increased.

Since the magnetoresistance effect elements 113 and 114 also have a coercive force in the magnetization free layer 11 as with the magnetoresistance effect elements 111 and 112, even if no magnetic field is applied from the magnetic field supply mechanism 127, the magnetization direction in the magnetization free layer 11 is maintained, eliminating the need to continue to apply a magnetic field from the magnetic field supply mechanism 127. Therefore, electric power used to drive the magnetic field supply mechanism 127 to apply a magnetic field to the magnetoresistance effect elements 113 and 114 can be conserved.

Although, in the seventh embodiment illustrated in FIG. 10, the magnetic field supply mechanism 127 connected to the current generating source 107 is formed with one conductor and controls magnetic fields applied to both the magnetoresistance effect elements 113 and 114 at the same time, it is also possible to place the magnetic field supply mechanism 127 in the vicinity of each of the magnetoresistance effect elements 113 and 114 and individually control the magnetic fields applied to both the magnetoresistance effect elements 113 and 114.

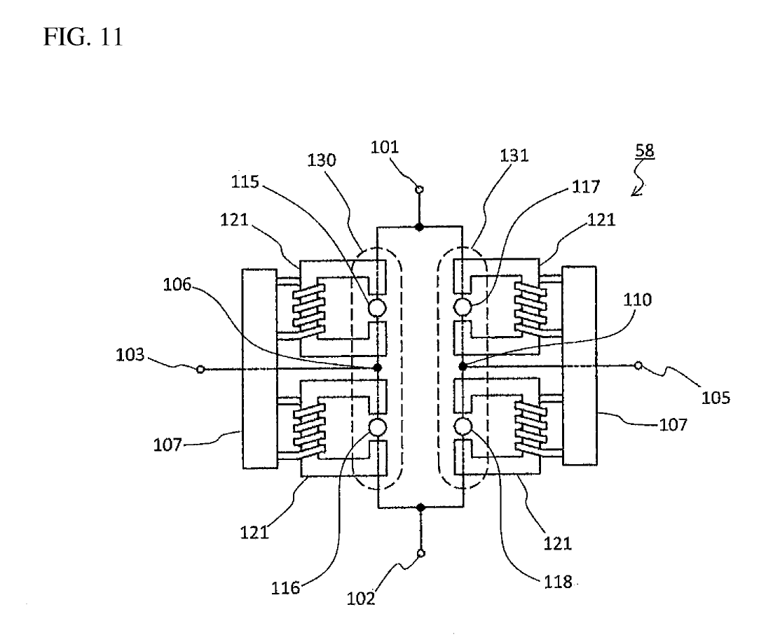

Next, the structure of a variable voltage circuit 58 according to an eighth embodiment of the present invention will be described with reference to FIG. 11.

The variable voltage circuit 58 in the eighth embodiment has a series resistor part 130, in which two magnetoresistance effect elements 115 and 116 are connected in series, and a series resistor part 131, in which two magnetoresistance effect elements 117 and 118 are connected in series, the two series resistor part being connected in parallel. The node 106 between the magnetoresistance effect elements 115 and 116 is connected to the output terminal 103, and the node 110 between the magnetoresistance effect elements 117 and 118 is connected to the output terminal 105. The series resistor parts 130 and 131 connected in parallel are connected to the first voltage source 101 and second voltage source 102 between the first voltage source 101 and the second voltage source 102. In the vicinity of each of the magnetoresistance effect elements 115, 116, 117, and 118, the magnetic field supply mechanism 121 that applies a magnetic field to the relevant magnetoresistance effect element 115, 116, 117, or 118 is disposed.

Table 3 indicates results of comparison of examples of output voltages obtained when the variable voltage circuit 51 indicated in the second embodiment is operated and examples of output voltages obtained when the variable voltage circuit 58 indicated in the eighth embodiment is operated. The magnetoresistance effect elements 108, 115, and 118 were the same element, and the magnetoresistance effect elements 109, 116, and 117 were the same element.

The magnetoresistance effect elements 108, 115, and 118 had an MR ratio of 100%, and the minimum value of their resistance value R₃ was 90 [Ω]. The magnetoresistance effect elements 109, 116, and 117 had an MR ratio of 100%, and the minimum value of their resistance value R₄ was 200 [Ω]. Output voltages when a difference in electric potential between the first voltage source 101 and the second voltage source 102 is 1 [V], that is, differences in electric potential between the output terminal 103 and the output terminal 105, and the difference between the maximum value and minimum value of the output voltages are indicated in Table 3.

TABLE 3

| | | Resistance value | | Output voltage [V] | |
|---|---|---|---|---|---|
| State of resistor | | [Ω] | | Second | Eighth |
| R₃ | R₄ | R₃ | R₄ | embodiment | embodiment |
| R₃ₘₐₓ | R₄ₘₐₓ | 180 | 400 | 0.69 | 0.38 |
| R₃ₘₐₓ | R₄ₘᵢₙ | 180 | 200 | 0.53 | 0.05 |
| R₃ₘᵢₙ | R₄ₘₐₓ | 90 | 400 | 0.82 | 0.63 |
| R₃ₘᵢₙ | R₄ₘᵢₙ | 90 | 200 | 0.69 | 0.38 |

| | | |
|---|---|---|
| ΔV_{OUT} | 0.29 | 0.58 |

Table 3 indicates that, with the variable voltage circuit 51 indicated in the second embodiment, the difference ΔV_{OUT} between the maximum value and minimum value of the output voltages is 0.29 [V] and that, with the variable voltage circuit 58 indicated in the eighth embodiment, the difference ΔV_{OUT} between the maximum value and minimum value of the output voltages is 0.58 [V], indicating a difference of 0.29 [V].

With the variable voltage circuit 58 in the eighth embodiment, in which two series resistor parts 130 and 131, in each of which a plurality of resistive elements (magnetoresistance effect elements) are connected in series, are provided and the two series resistor parts 130 and 131 are connected in parallel as described above, the output voltage range can be expanded.

A large output voltage range indicates that more types of voltages can be output in that range. When differences among output voltages are large, error due to variations in output voltages can be suppressed. Accordingly, a larger output voltage range is desirable as functions of a variable voltage circuit.

Although the above fourth to sixth and eighth embodiments have been explained by using examples in which the magnetic field applying mechanism 121 indicated in the first embodiment is used as the magnetic field applying mechanism, the magnetic field applying mechanism 122 indicated in the second embodiment or the magnetic field applying mechanism 125 indicated in the third embodiment may be used instead of the magnetic field applying mechanism 121.

### EMBODIMENTS

### Embodiment 1

A specific embodiment of the above sixth embodiment will be indicated.

As the magnetic field supply mechanism 121, an Au coil was wound around a NiFe magnetic core by using a thin-film process. The Au coil is such that the width of Au is 10 [m], its thickness is 200 [nm], and the number of turns is 4. The magnetic field supply mechanisms 121 were placed so that their pole ends were at positions 50 nm distant from the magnetoresistance effect elements 111 and 112.

The magnetization direction in the magnetization fixed layer 13 of the magnetoresistance effect elements 111 and 112 and the direction in which the magnetic field supply mechanism 121 applies a magnetic field are parallel.

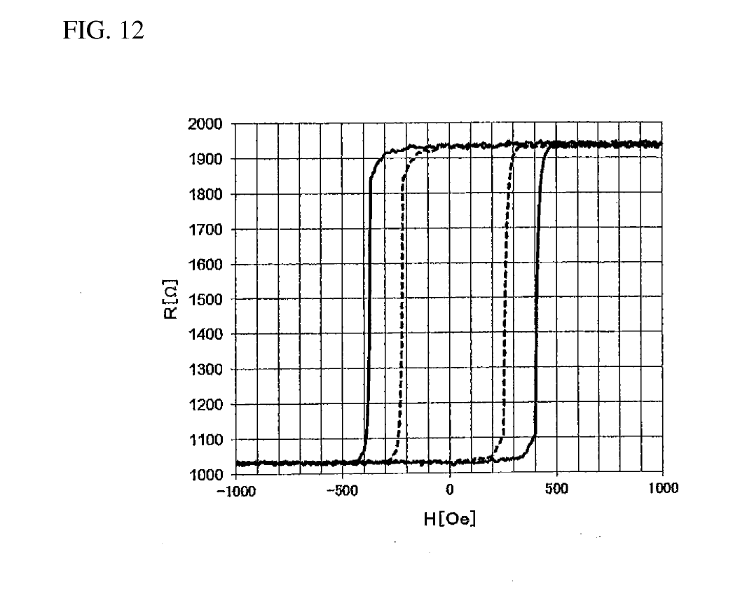

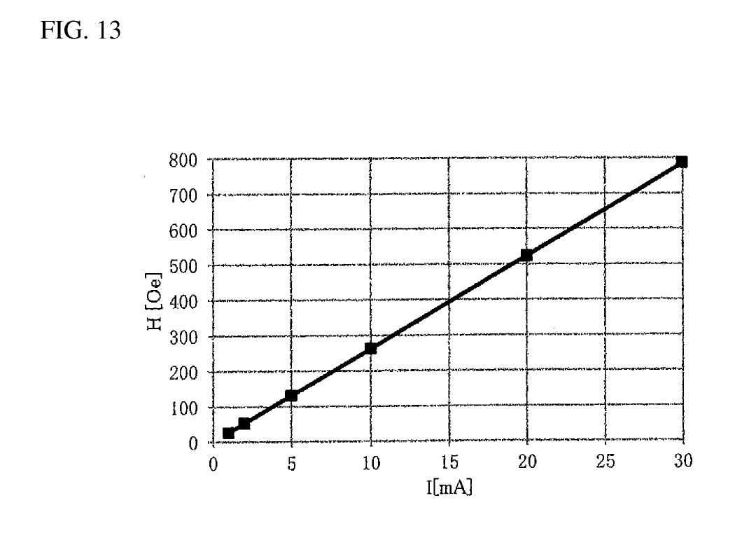

The graph in FIG. 12 indicates the magnetic characteristics of the magnetoresistance effect elements 111 and 112; the horizontal axis indicates magnetic field H applied to the magnetoresistance effect elements and the vertical axis indicates element resistance R of the magnetoresistance effect elements. The magnetoresistance effect element 111 has an MR ratio of 100%, and the minimum value of its resistance value is 200 [Ω]. The magnetic characteristics are as indicated by the dashed lines indicated in FIG. 12. A switching field in the magnetization direction in the magnetization free layer is at 400 [Oe]. When the strength of an external magnetic field applied by the magnetic field supply mechanism 121 is 400 [Oe] or higher, the resistance value of the magnetoresistance effect element 111 is maximized. The magnetoresistance effect element 112 has an MR ratio of 90%, and the minimum value of its resistance value is 150 [Ω]. The magnetic characteristics are as indicated by the solid lines indicated in FIG. 12. A switching field in the magnetization direction in the magnetization free layer is at 500 [Oe]. When the strength of an external magnetic field applied by the magnetic field supply mechanism 121 is 500 [Oe] or higher, the resistance value of the magnetoresistance effect element 112 is maximized. To invert the magnetization direction in the magnetization free layer of the magnetoresistance effect element 111, a magnetic field at 400 [Oe] or higher needs to be applied to the magnetization free layer of the magnetoresistance effect element 111. The magnetization direction in the magnetization free layer of the magnetoresistance effect element 111 can be inverted by applying a current at 15 [mA] or higher, as indicated by the graph indicated in FIG. 13, which represents the relationship between current flowing in the coil of the magnetic field supply mechanism 121 and the magnetic field generated from the end of the magnetic pole.

The graph in FIG. 13 also indicates the performance of the magnetic field supply mechanism 121; the horizontal axis indicates current I flowing in the coil of the magnetic field supply mechanism and the vertical axis indicates the magnetic field H generated from the end of the magnetic pole. Since the switching field in the magnetization direction in the magnetization free layer of the magnetoresistance effect element 112 is at 500 [Oe], the magnetization direction in the magnetization free layer of the magnetoresistance effect element 112 can be inverted by applying a current at 19 [mA] or higher, as indicated by the graph indicated in FIG. 13, which represents the relationship between current flowing in the coil of the magnetic field supply mechanism 121 and the magnetic field generated from the end of the magnetic pole.

When a voltage V_{H} (=3 [V]) is applied to the first voltage source 101 and a voltage V_{L} (=0 [V]) is applied to the second voltage source 102, if the resistance value R₈ of the magnetoresistance effect element 111 and the resistance value R₉ of the magnetoresistance effect element 112 are varied to the high-resistance state (H) and low-resistance state (L), four types of output voltages are obtained as the output voltage V_{OUT} obtained from the output terminal 103 as indicated in Table 4.

TABLE 4

| | | Output |
|---|---|---|
| | | voltage |
| Resistance state | Element resistance [Ω] | [V] |

| R6a | R7a | R6a | R7a | Vout |
|---|---|---|---|---|
| H | H | 400 | 285 | 1.25 |
| H | L | 400 | 150 | 0.82 |
| L | H | 200 | 285 | 1.76 |
| L | L | 200 | 150 | 1.29 |

### REFERENCE SIGNS LIST

11 magnetization free layer
12 spacer layer
13 magnetization fixed layer
50, 51, 52, 53, 54, 55, 56, 57, 58 variable voltage circuit
101 first voltage source
102 second voltage source
103, 105 output terminal
104 resistive element
106, 110 node
107 current generating source
108, 109, 111, 112, 113, 114, 115, 116, 117, 118 magnetoresistance effect element
121, 122, 125, 127 magnetic field supply mechanism
130, 131 series resistor part

What is claimed is:

1. A variable voltage circuit, wherein a plurality of resistive elements are connected in series between a first voltage source and a second voltage source, at least one of the plurality of resistive elements is a magnetoresistance effect element that has a magnetization fixed layer and a magnetization free layer with a spacer layer interposed therebetween, a magnetic field supply mechanism that applies a magnetic field to the magnetoresistance effect element is provided in a vicinity of the magnetoresistance effect element, the magnetic field supply mechanism is operable to vary a resistance value of the magnetoresistance effect element by varying the magnetic field, and one of nodes among the plurality of resistive elements is connected to an output terminal.

2. The variable voltage circuit according to claim 1, wherein the variable voltage circuit is structured so that a plurality of resistance values are obtained as at least one of a first resistance value between the first voltage source and the output terminal and a second resistance value between the second voltage source and the output terminal, and a plurality of types of output voltages are thereby obtained according to voltage division ratios obtained from the first resistance value and the second resistance value.

3. The variable voltage circuit according to claim 1, wherein a plurality of the magnetoresistance effect elements are included as the plurality of resistive elements, and the magnetization free layers of at least two of the plurality of magnetoresistance effect elements have mutually different coercive forces.

4. The variable voltage circuit according to claim 1, wherein a plurality of the magnetoresistance effect elements are included as the plurality of resistive elements, and at least one magnetic field supply mechanism is provided in a vicinity of each of the magnetoresistance effect element.

5. The variable voltage circuit according to claim 1, wherein the magnetic field supply mechanism is operable to vary the resistance value of the magnetoresistance effect element by changing a magnetization direction in the magnetization free layer with the magnetic field.

6. The variable voltage circuit according to claim 1, wherein the magnetic field supply mechanism is operable to vary the resistance value of the magnetoresistance effect element by varying a strength of a magnetic field to be applied to the magnetization free layer.

7. The variable voltage circuit according to claim 1, wherein two series resistor parts, in each of which the plurality of resistive elements are connected in series, are provided and the two series resistor parts are connected in parallel.

8. The variable voltage circuit according to claim 1, wherein the magnetic field supply mechanism maintains the resistance value of the magnetoresistance effect element by applying the magnetic field to the magnetoresistance effect element.

9. The variable voltage circuit according to claim 1, wherein a magnetization direction in the magnetization fixed layer of the magnetoresistance effect element and a magnetization direction in the magnetization free layer of the magnetoresistance effect element are maintained in a substantially parallel direction or a substantially antiparallel direction even in a state in which the magnetic field is not generated from the magnetic field supply mechanism.
